(19) United States
(12) Patent Application Publication
(10) Pub. No.: US 2014/0225731 A1
(43) Pub. Date: Aug. 14, 2014

(54) Monitoring System using Wireless Sensor Satellite Modules

(71) Applicant: Rueben Gouveia, Ozone Park, NY (US)

(72) Inventor: Rueben Gouveia, Ozone Park, NY (US)

(21) Appl. No.: 14/174,882

(22) Filed: Feb. 7, 2014

Related U.S. Application Data
(60) Provisional application No. 61/763,727, filed on Feb. 12, 2013.

(51) Int. Cl. G08B 25/10; H04W 88/08; H04B 7/24

(52) U.S. Cl. CPC G08B 25/10; H04B 7/24; H04W 88/08
USPC 340/539.22

(57) ABSTRACT

A system of monitoring the conditions within an interior space using a plurality of wirelessly connected sensor satellites is provided, wherein the satellites each contain a number of electrical sensors for monitoring emergency events and coordinate with a main hub within the structure. A satellite is placed within each area to be monitored, wherein each includes at least a fire sensor and a carbon monoxide sensor, and optionally includes a wired connection to various electrical outlets for monitoring the same. The satellites may also include motion sensors. Combined, each satellite coordinates its telemetry with a main hub via wireless communications, which can then be interpreted to alert a homeowner, business owner, or forwarded to emergency services for dispatch of fire and police services. A third party monitoring services is also contemplated.

### CROSS REFERENCE TO RELATED APPLICATION

This application claims the benefit of U.S. Provisional Application No. 61/763,727 filed on Feb. 12, 2013. The above identified patent application is herein incorporated by reference in its entirety to provide continuity of disclosure.

### BACKGROUND OF THE INVENTION

1. Field of the Invention

The present invention relates to home monitoring systems and home security systems that utilize a plurality of sensors to monitor for smoke, carbon monoxide, heat, and other home security variables. The present invention contemplates a security system that deploys individual sensor satellite modules throughout a residence, wherein each satellite employs a plurality of sensors and communicates its status to a main module in the home. The system may further coordinate with outside authorities or a private monitoring service in the event of an emergency.

Many dwellings and buildings requires safety systems for monitoring for emergency events or for security breaches. These generally include various installations that monitor variables such as heat and smoke, carbon monoxide, motion detection, and the like. The necessary equipment and installation of different monitoring devices can be expensive and take up a substantial space within a structure. In addition, most devices are not part of an integrated system and may prevent a building monitor or manager from becoming aware of an issue in a timely manner.

Most commonly installed monitoring systems are either wired into an integrated building monitoring system or operate as independent units. The independent units are generally for providing an audible warning to those in the immediate vicinity, while the integrated systems allow for a main controller or external service to monitor the status of the system. Each of these options has their drawbacks. the integrated system is very complex and very expensive to install, particularly after a building has been finished. The system requires wired connections between all sensors, and a location for a main controller. Likewise the independent monitoring devices are merely for local warnings, and provide an administrator with no means of monitoring the status of the sensor from a centralized location or location distant from the sensor deployment area.

The present invention provides a monitoring system that comprises one or more remote satellite modules that are deployed throughout a residence or building, wherein the modules wirelessly communicate to a main controller module in a different location within the building. The wireless signal can be boosted at given locations; however there is no wired connection between the satellite modules and the main module. Each satellite module comprises a plurality of sensors for detecting different emergency events, and further includes a tampering and an inoperative sensor means that notifies the main module of a sensor or complete satellite module failure (non-responsiveness or similar fault). The system therefore provides a wireless means of monitoring a larger dwelling or building, wherein wired connections are not required and different parts of the building can be monitored from a centralized location.

2. Description of the Prior Art

Devices have been disclosed in the prior art that relate to alarm systems and monitoring services. These include devices that have been patented and published in patent application publications, and generally relate to specific sensor types or monitoring services that require rigorous installation when deployed. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Patent Publication No. 2012/0229285 to Rauworth, which discloses a fire and carbon monoxide detection system that integrates the fire detection and carbon monoxide sensors into one system. The system comprises a smoke detector, a carbon monoxide detector, and a first and second conductor therebetween, wherein the two detectors clamp the two conductors. This signals a fault for the system to register a carbon monoxide or fire event. While disclosing a sensor mechanism that integrates fire and carbon monoxide detection, the Rauworth disclose fails to anticipate a larger system that utilizes wireless transmission of sensor data to a main module for whole-building monitoring.

U.S. Pat. No. 5,450,065 to Greenfield discloses a fire alarm system that employs at least one pair of sensor leads and a heat-sensitive alarm trigger that uses a electrolytic material disposed between electrodes to allow current to flow therebetween and trigger the alarm circuit. The Greenfield device is an example of one fire alarm sensor deployed in the art, yet does not disclose a larger system in which several sensors are disposed within a sensor satellite assembly. The present invention discloses a satellite sensor assembly that can monitor several events within a home and wireless communicate to a central hub for processing and for alert purposes.

U.S. Pat. No. 8,265,776 to Osann, Jr. discloses an energy monitoring system and method that utilizes portable monitoring points having at least one power plug receptacle. Rather than monitoring for smoke, heat, or carbon monoxide, the Osann, Jr. device is related to power consumption and electrical current drawn by an electrical load connected to at least one power plug receptacle. The remote device wirelessly transmits power consumption data to a central device. This data is used to calculate power consumption cost corresponding to the power plug receptacles. The Osann, Jr. device is similar in that it utilizes a wireless module to communicate data regarding sensor data collected; however the main focus, the structure, and the purpose of the Osann, Jr. significantly diverges from that of a home security monitoring system using remote satellite modules.

U.S. Pat. No. 4,521,645 to Carroll discloses an alarm system that deploys a plurality of smoke or heat detectors throughout a building and contemplates automatic telephone dialers connected thereto. The automatic dialers use a modem in connection with a phone line to dial out to emergency services if a fire event is detected. The Carroll device contemplates each of the detectors deployed in the building to be connected to automatic dialers, which are connected via a telephone line. While this method of transferring alerts and signals is useful, it requires installation of telephone lines throughout a building or relies on the existence thereof. The present invention contemplates a plurality of wireless satellites that can be deployed without a wired connection to a main hub. This provides the administrator or homeowner with flexibility when deploying each of the satellites, wherein the wireless signal can be sent without installation of a wired connection and the signal can be boosted at given intervals if greater distances from the main hub are required.

Finally, U.S. Pat. No. 8,321,885 to Pino, Jr. discloses an in-home system for monitoring surveillance cameras, security systems, HVAC systems, lighting systems and the like using a wireless communications with a server and a television display alert for the user. The system communicates over a wireless network and alerts a user of an in-home system event using a pop-up screen on a digital television. This allows the user to take action or be prompted for action via a digital alert while watching television. Similar to the present invention in that wireless communication is used between various sensors and a main hub, the Pino, Jr. device is related to television use and alerting a user who is nearby or watching the same. The present invention contemplates a means of monitoring a plurality of satellite sensor assemblies over a wireless network and alerting either the user or an outside security service of an event.

The present invention provides a new and novel monitoring system for an interior space, wherein individually deployed sensor satellites are placed throughout a structure to monitor a number of different emergency events or variables in their local space. The satellites coordinate with a main hub within the building, which can direct attention to a building or home owner, and further to emergency services or a monitoring company. It is submitted that the present invention substantially diverges in elements from the prior art, and consequently it is clear that there is a need in the art for an improvement to existing interior monitoring systems. In this regard the instant invention substantially fulfills these needs.

### SUMMARY OF THE INVENTION

In view of the foregoing disadvantages inherent in the known types of monitoring systems for building and homes now present in the prior art, the present invention provides a new system that can be utilized for providing convenience for the user when monitoring different rooms or areas of a building without physical connections between the individual sensor satellites and a main hub that monitors all sensor activity.

It is therefore an object of the present invention to provide a new and improved monitoring system that has all of the advantages of the prior art and none of the disadvantages.

It is another object of the present invention to provide a monitoring system that is comprised of a plurality of individual sensor boxes or satellites, which are individually installed within a room or building space, and wherein the devices are self-contained and requiring only a power source to operate and initiate alerts for further processing.

Another object of the present invention is to provide a monitoring system that coordinates the activities and signals from the individual satellites using a main hub or central processing means, wherein the signal of each satellite is monitored for further action.

Yet another object of the present invention is to provide a monitoring system that combine several emergency monitoring sensors into a combined electrical unit (e.g. a satellite), wherein different fire, security, carbon monoxide, and similar emergency events can be monitored using a single assembly deployed within a given room.

Another object of the present invention is to provide a monitoring system that utilizes wirelessly communication between satellites and the main hub, wherein the main hub is adapted to interpret the satellite signal and coordinate alerts or emergency services based on received inputs.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of a dwelling wherein the present system is deployed and functioning.

FIG. 2a shows a view of the individual satellites wirelessly connected to a main hub for processing of information therefrom.

FIG. 2b shows a view of the individual satellites wirelessly connected to an outside monitoring service for processing of information therefrom.

FIG. 3 shows a diagram of an example sensor satellite of the present invention.

FIG. 4 shows a view of the system in operation, wherein the main hub may process the satellite signals and take further actions to outside parties.

### DETAILED DESCRIPTION OF THE INVENTION

Reference is made herein to the attached drawings. Like reference numerals are used throughout the drawings to depict like or similar elements of the monitoring system of the present invention. For the purposes of presenting a brief and clear description of the present invention, the preferred embodiment will be discussed as used for monitoring the interior space of a dwelling or building using wirelessly connected sensor satellites a main hub for processing the signals therefrom. The figures are intended for representative purposes only and should not be considered to be limiting in any respect.

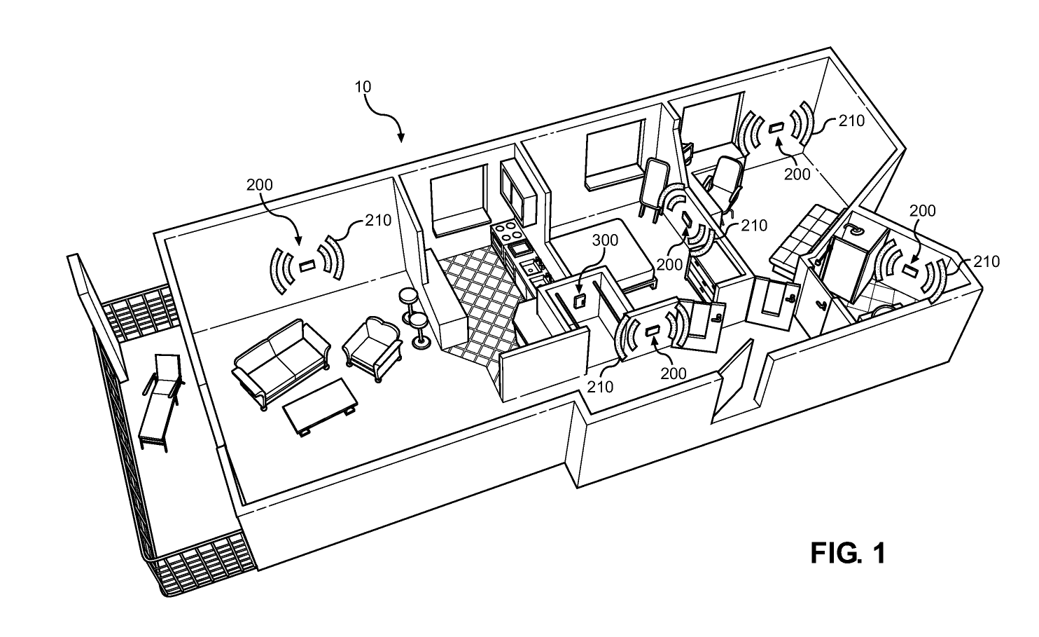

Referring now to FIG. 1, there is shown a view of a dwelling 10 in which the monitoring system of the present invention is deployed and in operation. The present system comprises one or more independently installed and operated sensor satellites 200. The satellites 200 are individual electrical assemblies that house a plurality of sensors and draw power from a local power source (either A/C power or onboard battery power). The satellites 200 are designed to coordinate with a main hub 300 or terminal within the dwelling, which simultaneously monitors each satellite 200 and can take action if one or more of the sensors detects an event. The satellites 200 are installed in a convenient location within a room and do not require a physical signal connection (e.g. wired connection) with the main hub 300, but rather wirelessly communicate therewith over a wireless network using a short range wireless signal 210 (e.g. a Wi-Fi connection or the like).

Each of the satellites 200 is designed to be independent and monitor the local area in which they are deployed. Several sensors are contemplated for each satellite 200, including those related to fire and emergency events, as well as security and monitoring capability. The satellite 200 uses commonly available electrical sensors for smoke, heat, and carbon monoxide, as well as motion sensors and other security sensors (window breakage sensor, etc.). When a sensor on a satellite 200 has interpreted an event, that event is communicated to the main hub 300 for further action. Also contemplated is a local audible alarm on the satellite 200. During operation, there exist operational lights on each satellite 200, which illuminate for the user to recognize whether there is a problem with the wireless connectivity of the system or a fault with one or more sensor in the satellite assembly.

The primary advantage of this system is the modularity and post-construction installation ease with which the system can be deployed. The satellites 200 are self-contained assemblies that are deployed along an interior surface and powered either by an onboard, replaceable battery, or are wired or otherwise connected to a building power source. The main hub 300 includes a wireless network (e.g. a modem and wireless router/antenna), wherein each of the satellites 200 includes a wireless antenna to join the local wireless network and communicate to the hub 300 using the same. This allows for installation of the satellites in any convenient location and without requiring physical wiring of the building to connect all satellites 200. Furthermore, for larger homes or buildings, wireless network repeaters or boosters are deployed to extend the wireless network to a greater range, thereby providing for connection of each satellite to the main hub 300 despite greater distances therebetween.

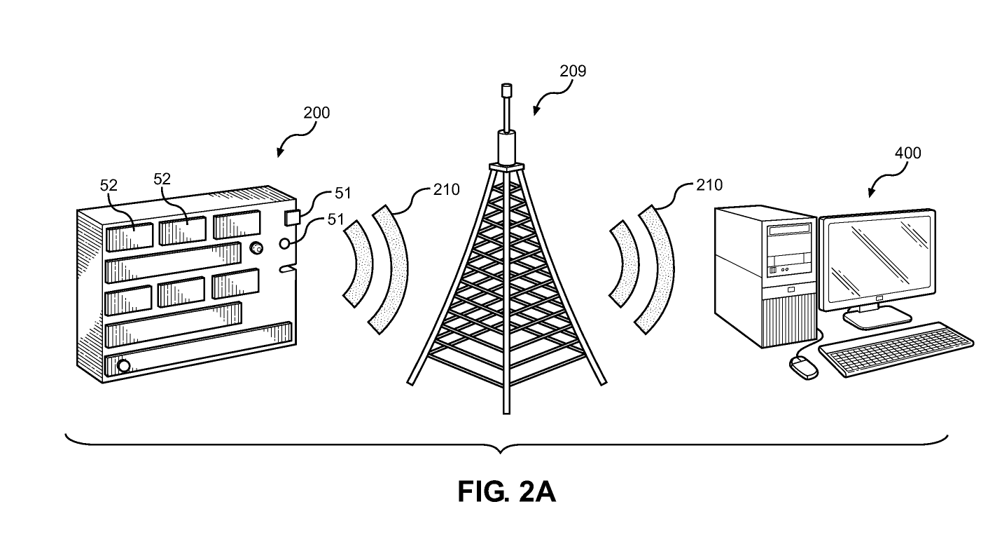

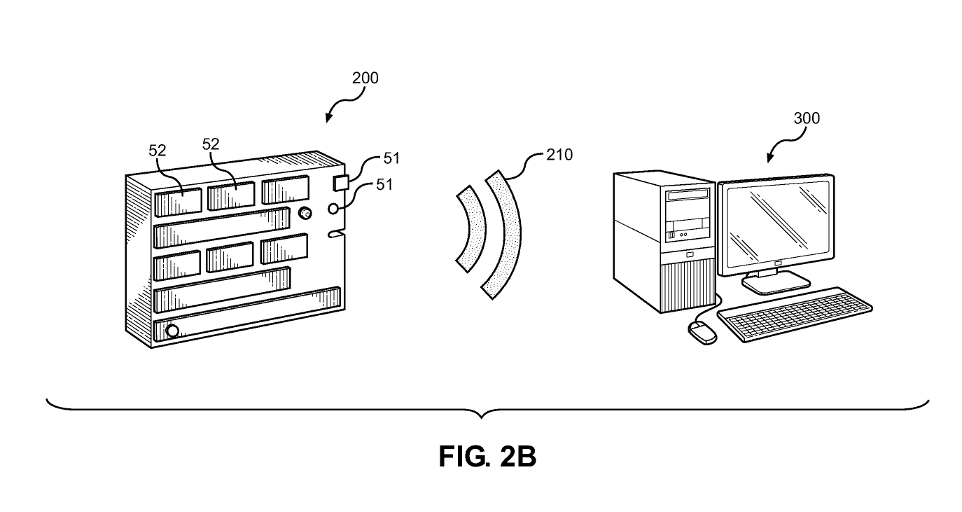

Referring now to FIGS. 2A and 2B, there are shown two wireless transmission options of the present invention. It is contemplated that the satellites 200 of the present invention are independent electrical assemblies that wirelessly communicate with a central hub. It is further contemplated that eth means of transmission and the type of wireless network may take on different forms, including a short range wireless network (e.g. Wi-Fi connection), or alternatively a cellular network 209. FIG. 2A provides a satellite 200 that includes a number of different indicators 52 and status lights 51 thereon, along with an imbedded cellular communication means therein. In this embodiment, each satellite has its own unique electronic serial number (ESN) assigned during manufacture and an identification number issued by a cellular network service provider. In this embodiment, the satellites 200 are not limited by a local network range and can directly dial a remote hub or external service across the country, or even the world.

In the cellular network connectivity embodiment, the satellite 200 can connect and send data signals 210 over a cellular network to remote hub or to an external monitoring service 400 monitoring the status of the satellite sensors. It is contemplated that non-local monitoring may be desired for tracking events and initiating emergency services when the user or owner of the home is not present and cannot respond accordingly, or further when a local hub is not desired.

Referring now to FIG. 2B, there is shown a view of the preferred embodiment of the present invention, in which each satellite communicates using a local wireless network. In this embodiment, wireless signals 210 are sent over a local network (e.g. Wi-Fi network) between a local main hub 300 and the satellite 200. The satellite includes a wireless adapter and an antenna for broadcasting and receiving signals across the network. The status of the network connection and the status of the various sensors can be monitored over the network, and further by visual inspection of the satellite 200 itself. The satellites 200 include operational indicator lights 51 and status lights 52 during operation.

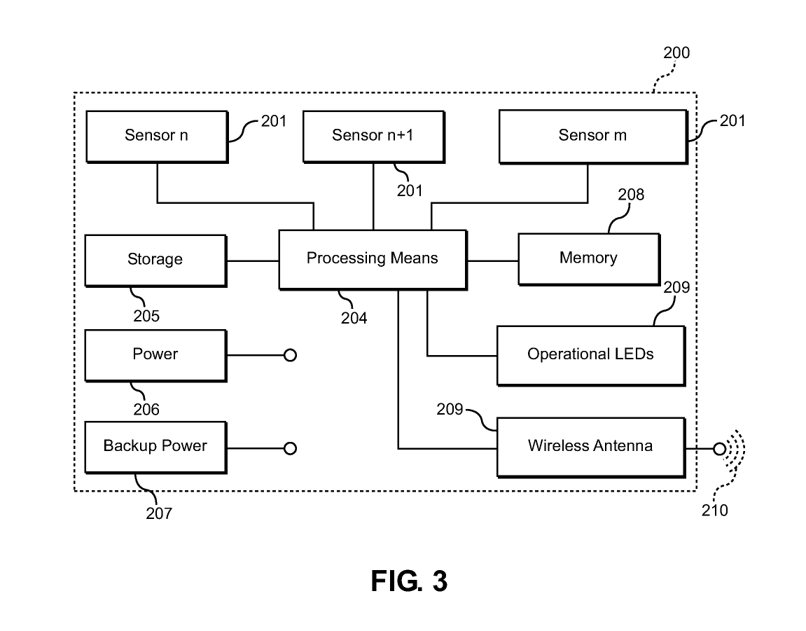

Referring now to FIG. 3, there is shown a view of a satellite 200 and some of its contemplated hardware. Each of the satellites includes a processing means 204 (e.g. a CPU or microprocessor), computer storage 205, and computer memory 208. The processing means 204 coordinates the functions of the satellite 200 and receives signals from each of the sensors deployed therein. The processing means 204 further sends out signals via a wireless antenna 209 across the wireless network 210 or the cellular network, wherein the status of the assembly can be communicated to a main hub or monitoring service. The contemplated sensors 201 deployed on each satellite include, inter alia, a fire sensor (heat or smoke detector), a carbon monoxide sensor, a motion sensor, a window glass breakage sensor (sound sensor), and an electrical outlet sensor (heat or smoke detector wired to a nearby electrical outlet). Finally, each of the sensors is powered 206 by either an onboard power source or an external power source connected thereto. Onboard backup battery power 207 may also be deployed in the event of an electrical blackout.

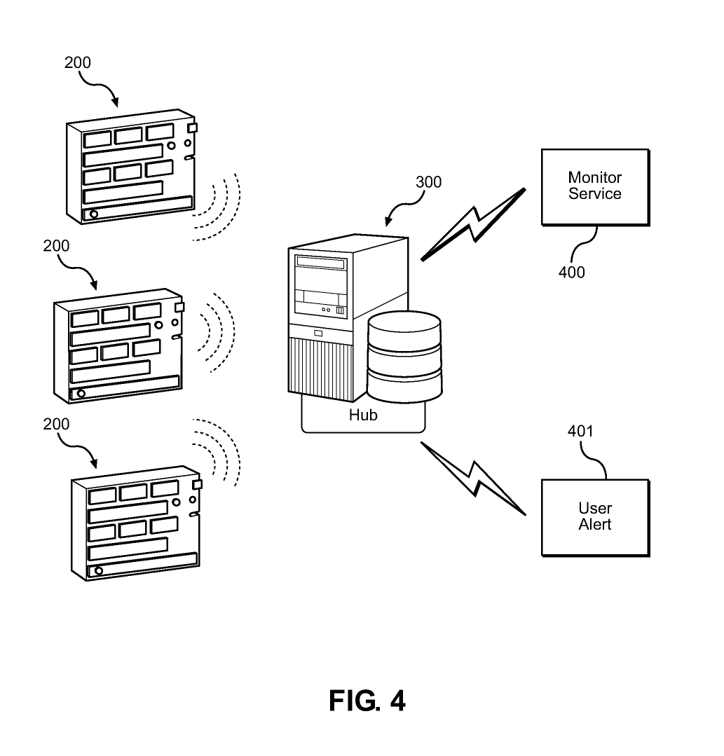

Referring to FIG. 4 there is shown a view of the system in operation, wherein the satellites 200 are each wirelessly connected to a main hub 300 within the building. The satellites communicate over a local wireless network, whereafter the signals are interpreted by the main hub 300. If action is necessary or if the satellites 200 report an event, the main hub can alert a user 401 either with a local audible alarm or a digital signal sent to a cell phone or the like. Furthermore, the main hub can communicate with an outside monitoring service 400 for appropriate action. This embodiment is one in which the satellites 200 coordinate with a main hub 300 using a local network, as opposed to connecting to an outside terminal over a cellular network.

Monitoring buildings and dwellings for emergency events and for security is critical for safety. However, the necessary equipment and installation of different devices can be quite expensive, and furthermore such equipment generally consumes a substantial space within a structure. In addition, most devices are not part of one system and may prevent a building monitor or manager from becoming aware of an issue in a timely manner. The present invention describes a structure monitoring system. The system comprises a sensor satellite housing that contains several sensors and a wireless communication capability. The system utilizes a central hub to each of the satellites and to take action if an event is recorded by any of the satellites. In addition to the monitoring system, the device includes a number of satellite monitoring devices and a transmission means to communicate with emergency services. During an emergency event, the system sends an alert to either the user or to emergency services to notify them of the occurrence. The system improves the safety of the building while installed and consolidates several sensors into independently deployable satellites that are simultaneously monitored from one central location.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A monitoring system using independently deployed and wireless sensor satellites, comprising:
at least one sensor satellite adapted to be deployed within an interior space;
said sensor satellite comprising a processing means, at least one sensor, a wireless antenna, and a power source;
each sensor satellite being wirelessly connected to a main hub via a wireless network;
said at least one sensor comprising at least a smoke detector and a carbon monoxide sensor;
said main hub being adapted to communicate with all of said sensor satellites and signal third parties of an event registered by one or more of said sensor satellites.

2. The monitoring system of claim 1, wherein at least one of said sensor satellites further comprise a motion sensor.

4. The monitoring system of claim 1, wherein at least one of said sensor satellites further comprise a window breakage sensor.

5. The monitoring system of claim 1, wherein at least one of said sensor satellites further comprise an electrical outlet sensor.

6. The monitoring system of claim 1, wherein at least one of said sensor satellites further comprise an electrical outlet sensor.

7. The monitoring system of claim 1, wherein said network comprises a short range wireless network.

8. The monitoring system of claim 1, wherein said network comprises a cellular network.
